(19) United States
(12) Patent Application Publication
(10) Pub. No.: US 2019/0332566 A1
(43) Pub. Date: Oct. 31, 2019

(54) COMMUNICATION APPARATUS AND COMMUNICATION METHOD

(71) Applicant: SONY SEMICONDUCTOR SOLUTIONS CORPORATION, KANAGAWA (JP)

(72) Inventors: KENTARO YASUNAKA, TOKYO (JP); TAKASHI MASUDA, TOKYO (JP)

(21) Appl. No.: 16/475,274

(22) PCT Filed: Dec. 28, 2017
(86) PCT No.: PCT/JP2017/047370

§ 371 Date: Jul. 1, 2019

(30) Foreign Application Priority Data
Jan. 12, 2017 (JP) 2017-003362

(51) Int. Cl. G06F 13/42; H04L 25/02; H04L 12/40

(52) U.S. Cl. CPC G06F 13/4282; G06F 2213/0042; H04L 12/40032; H04L 25/0282

(57) ABSTRACT

The present technology relates to a communication apparatus and a communication method that enable an increase in the variation of modes of connection between electronic devices. Included are: a detected mechanism corresponding to a mechanism included in a second electronic device that receives a baseband signal outputted by a first electronic device, the detected mechanism being configured to, upon the first electronic device and the second electronic device being connected, be detected by the first electronic device, and be connected to the first electronic device; a connection unit configured to, upon a connection of the first and second electronic devices being detected, connect the detected mechanism to the first electronic device; and a millimeter-wave generation unit configured to generate a signal in a millimeter wave band obtained by converting frequency from the baseband signal outputted by the first electronic device to a signal in a higher frequency band than the baseband signal. When the connection unit is connected and the baseband signal is being inputted, the millimeter-wave generation unit generates the signal in the millimeter wave band. The present technology can be applied to, for example, connection where a universal serial bus (USB) host recognizes a connection to a USB device.

### TECHNICAL FIELD

The present technology relates to a communication apparatus and a communication method, and particularly relates to a communication apparatus and a communication method that enable an increase in the variation of modes of connection of electronic devices that conform to, for example, the universal serial bus (USB) specifications, such as a USB host and a USB device.

### BACKGROUND ART

Examples of the electronic devices that conform to the USB specifications include (an electronic device that serves as) a USB host and (an electronic device that serves as) a USB device.

The USB host and the USB device are connected using, for example, a USB cable. The USB host takes the initiative to control communication between the USB host and the USB device.

The USB specifications support bus-power(ed). The USB cable can supply the power, in addition to a signal (data), from the USB host to the USB device.

However, the USB specifications specify the upper limit of current that one USB cable can supply as the power. Hence, a technology for supplying the power from a USB host to a USB device whose amount of current consumed exceeds the upper limit specified in the USB specification has been proposed (refer to, for example, Patent Document 1).

### CITATION LIST

### Patent Document

Patent Document 1: Japanese Patent Application Laid-Open No. 2012-008716

### SUMMARY OF THE INVENTION

### Problems to be Solved by the Invention

Incidentally, in terms of connection of electronic devices, it is being requested to increase the variation of connection modes.

The present technology has been made considering such circumstances and is for enabling an increase in the variation of modes of connection of electronic devices.

### Solutions to Problems

A communication apparatus according to one aspect of the present technology includes: a detected mechanism corresponding to a mechanism included in a second electronic device that receives a baseband signal outputted by a first electronic device, the detected mechanism being configured to, upon the first electronic device and the second electronic device being connected, be detected by the first electronic device, and be connected to the first electronic device; a connection unit configured to, upon a connection of the first and second electronic devices being detected, connect the detected mechanism to the first electronic device; and a millimeter-wave generation unit configured to generate a signal in a millimeter wave band obtained by converting frequency from the baseband signal outputted by the first electronic device to a signal in a higher frequency band than the baseband signal, in which upon the connection unit being connected and the baseband signal being inputted, the millimeter-wave generation unit generates the signal in the millimeter wave band.

A communication method according to one aspect of the present technology is a communication method of a communication apparatus having a detected mechanism corresponding to a mechanism included in a second electronic device that receives a baseband signal outputted by a first electronic device, the detected mechanism being configured to, upon the first electronic device and the second electronic device being connected, be detected by the first electronic device, and be connected to the first electronic device, the communication method including: upon a connection of the first and second electronic devices being detected, connecting the detected mechanism to the first electronic device; and generating a signal in a millimeter wave band obtained by converting frequency from the baseband signal outputted by the first electronic device to a signal in a higher frequency band than the baseband signal, in which upon the detected mechanism being connected to the first electronic device and the baseband signal being inputted, the signal in the millimeter wave band is generated.

In the communication apparatus and the communication method according to one aspect of the present technology, the detected mechanism is included which corresponds to the mechanism included in the second electronic device that receives the baseband signal outputted by the first electronic device, and is configured to, upon the first electronic device and the second electronic device being connected, be detected by the first electronic device, and be connected to the first electronic device. In a case where a connection of the first and second electronic devices is detected, the detected mechanism is connected to the first electronic device. The signal in the millimeter wave band is generated which is obtained by converting frequency from the baseband signal outputted by the first electronic device to the signal in the higher frequency band than the baseband signal. Moreover, when the detected mechanism is connected to the first electronic device and the baseband signal is being inputted, the signal in the millimeter wave band is generated.

Incidentally, the communication apparatus may be an independent apparatus, or may be an internal block configuring one apparatus.

### Effects of the Invention

According to the present technology, it is possible to increase the variation of modes of connection of electronic devices.

Incidentally, the effects described herein are not necessarily limited, and any effect described in the present disclosure is sufficient.

### BRIEF DESCRIPTION OF DRAWINGS

FIG. 1 is a diagram illustrating an example of the configuration of a communication system where electronic devices are connected by an electrical cable.

FIG. 2 is a diagram explaining an example of the operation of the communication system.

FIG. 3 is a diagram illustrating an example of the configuration of a communication system that transfers data by modulated signals in the millimeter wave band.

FIG. 4 is a block diagram illustrating an example of the configurations of communication units.

FIG. 5 is a diagram for explaining the configuration of a transmitting unit.

FIG. 6 is a diagram for explaining another configuration of the transmitting unit.

FIG. 7 is a diagram for explaining the configuration of a receiving unit.

FIG. 8 is a diagram for explaining changes of state.

FIG. 9 is a diagram for explaining changes of state.

FIG. 10 is a diagram for explaining another configuration of the transmitting unit.

FIG. 11 is a diagram for explaining another configuration of the transmitting unit.

FIG. 12 is a flowchart for explaining a process related to establishment of a communication channel.

FIG. 13 is a diagram illustrating another example of the configuration of the communication system.

FIG. 14 is a diagram illustrating another example of the configuration of the communication system.

FIG. 15 is a diagram illustrating another example of the configuration of the communication system.

### MODE FOR CARRYING OUT THE INVENTION

A mode for carrying out the present technology (hereinafter referred to as the embodiment) is described hereinafter.

<Communication System Where Electronic Devices Are Connected by Electrical Cable>

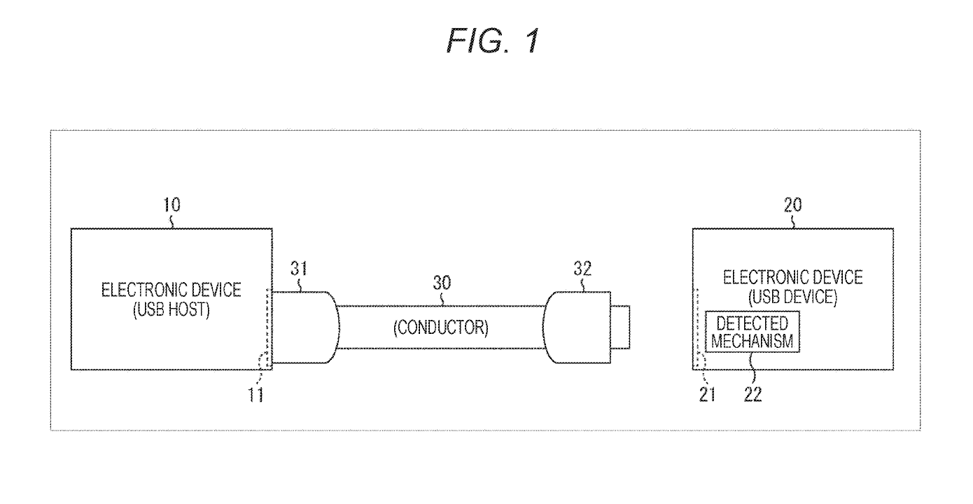

FIG. 1 is a diagram illustrating an example of the configuration of a communication system where electronic devices are connected by an electrical cable.

In the communication system of FIG. 1, an electronic device 10 and an electronic device 20 are connected by an electrical cable 30.

The electronic device 10 includes a connector 11 that can be connected to a connector 31 of the electrical cable 30, and is configured to be capable of exchanging (inputting and outputting) baseband signals at baseband with another device such as the electronic device 20 via the connector 11.

The electronic device 20 includes a connector 21 that can be connected to a connector 32 of the electrical cable 30, and is configured to be capable of exchanging (inputting and outputting) baseband signals at baseband with another device such as the electronic device 10 via the connector 21.

Moreover, the electronic device 20 includes a detected mechanism 22 that is detected by the electronic device 10 when the electronic device 10 and the electronic device 20 that receives a baseband signal outputted by the electronic device 10 are connected.

The electrical cable 30 is a cable including a conductor used to convey an electrical signal as a baseband signal (hereinafter also referred to as the baseband conductor) as the core (a wire connecting the connector 31 and the connector 32). The electrical cable 30 is provided at one end with the connector 31 that is connected to the electronic device 10, and at the other end with the connector 32 that is connected to the electronic device 20.

In the communication system configured as described above, when the electronic devices 10 and 20 are connected using the electrical cable 30, in other words, when the connector 11 of the electronic device 10 and the connector 31 of the electrical cable 30 are connected, and the connector 21 of the electronic device 20 and the connector 32 of the electrical cable 30 are connected, the detected mechanism 22 included in the electronic device 20 is detected via the electrical cable 30 in the electronic device 10. The detection of the detected mechanism 22 allows recognizing the connection to the electronic device 20.

As described above, the method in which a connection of electronic devices is detected (recognized) on the basis of the detection of the detected mechanism 22 is employed in, for example, the USB (USB 3.0) specification.

The present technology is described below, assuming that the electronic devices 10 and 20 are electronic devices that conform to, for example, the USB specification.

In a case where the electronic devices 10 and 20 are electronic devices that conform to the USB specification, the electronic device 10, the electronic device 20, and the electrical cable 30 are a USB host, a USB device, and a USB cable, respectively, and are also mentioned below as the USB host 10, the USB device 20, and the USB cable 30.

Moreover, in the case where the electronic devices 10 and 20 are electronic devices that conform to the USB specification, the connector 11 of the electronic device 10 and the connector 21 of the electronic device 20 are USB connectors (sockets) (receptacles). The connector 11 and the connector 21 are also mentioned below as the USB connector 11 and the connector 21, respectively.

Furthermore, in the case where the electronic devices 10 and 20 are electronic devices that conform to the USB specification, the connectors 31 and 32 of the USB cable 30 are USB connectors (plugs). The connector 31 and the connector 32 are also mentioned below as the USB connector 31 and the USB connector 32, respectively.

The USB host 10 is an electronic device, such as a personal computer (PC) or a digital camera, which operates by receiving the supply of power from an external power supply independently (not being bus-powered) or receiving the supply of power from an internal battery, and has at least a function to be the USB host.

In terms of the USB host 10, the USB connector 31 of the USB cable 30 is inserted into the USB connector 11 included in the USB host 10 to connect (couple) the USB connectors 11 and 31.

The USB device 20 is an electronic device, such as a disk drive, which operates by receiving the supply of power based on bus power or receiving the supply of power from an external power supply or an internal battery, and has at least a function to be the USB device.

In terms of the USB device 20, the USB connector 32 of the USB cable 30 is inserted into the USB connector 21 included in the USB device 20 to connect the USB connectors 21 and 32.

The USB cable 30 is a cable that conforms to the USB specification, and is provided at one end with the USB connector 31 that is connected to the USB host 10, and at the other end with the USB connector 32 that is connected to the USB device 20. The core of the USB cable 30 comprises, for example, a baseband conductor such as copper.

In the communication system configured as described above, when the USB host 10 and the USB device 20 are connected using the USB cable 30, the detected mechanism 22 included in the USB device 20 is detected via the USB cable 30 in the USB host 10. The detection of the detected mechanism 22 allows recognizing the connection to the USB device 20.

The detected mechanism 22 included in the USB device 20 includes resistance as the common-mode impedance employed in, for example, the USB 3.0 specification and the USB 3.1 specification.

When the USB host 10 and the USB device 20 are connected, the common-mode impedance being the detected mechanism 22 included in the USB device 20 is (electrically) connected to the USB host 10. As a result, impedance as viewed from (an interior side of) the USB host 10 toward the USB connector 11 side changes between a case where the USB host 10 and the USB device 20 are not connected and a case where the USB host 10 and the USB device 20 are connected.

In the USB host 10, the connection to the USB device 20 is recognized (detected) if the impedance as viewed from the USB host 10 toward the USB connector 11 side is impedance of the case where the common-mode impedance being the detected mechanism 22 is connected to the USB host 10.

Incidentally, in the USB host 10, the impedance as viewed from the USB host 10 toward the USB connector 11 side, that is, the common-mode impedance being the detected mechanism 22, is equivalently detected by detecting the time constant of voltage as viewed from the USB host 10 toward the USB connector 11 side (the rate of change of voltage as viewed from the USB host 10 toward the USB connector 11 side).

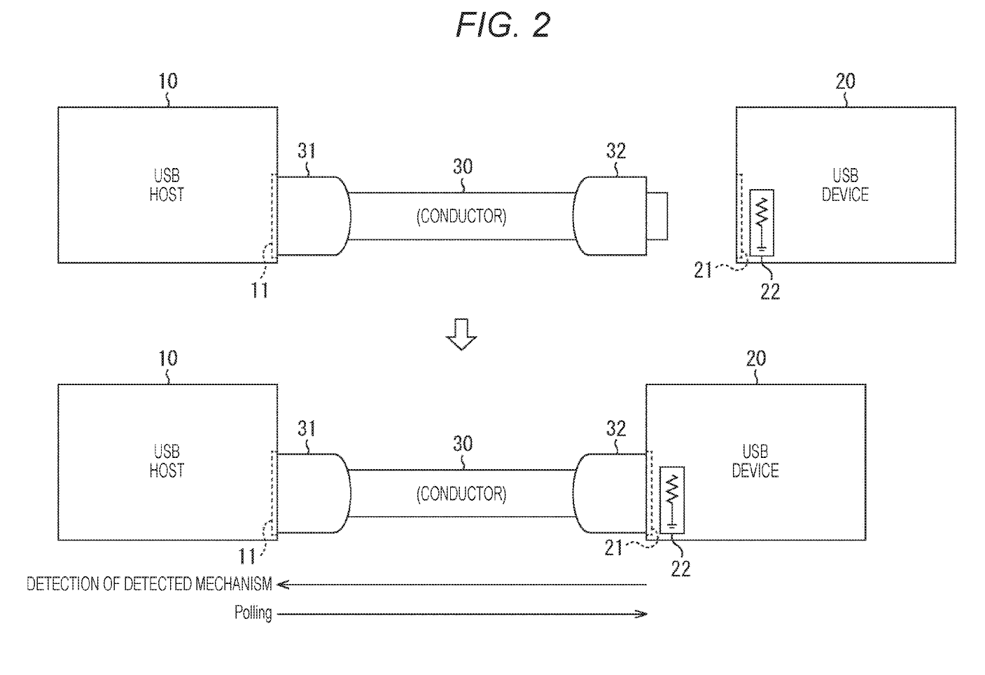

FIG. 2 is a diagram explaining an example of the operation of the communication system of FIG. 1.

In the case where the USB host 10 and the USB device 20 are not connected, the detected mechanism 22 included in the USB device 20 is not connected to the USB host 10. Accordingly, the USB host 10 cannot detect the detected mechanism 22.

When the USB host 10 and the USB device 20 are connected via the USB cable 30, the detected mechanism 22 included in the USB device 20 is connected to the USB host 10 via the USB cable 30. The detected mechanism 22 is detected in the USB host 10.

When detecting the detected mechanism 22, the USB host 10 recognizes (detects) the connection to the USB device 20, transitions to a polling state for polling, and starts outputting a baseband signal as polling from the USB connector 11.

When the USB device 20 responds to polling from the USB host 10, then the USB host 10 and the USB device 20 enter a state of being able to communicate (exchange baseband signals).

### <Communication System That Transfers Data by Modulated Signals in Millimeter Wave Band>

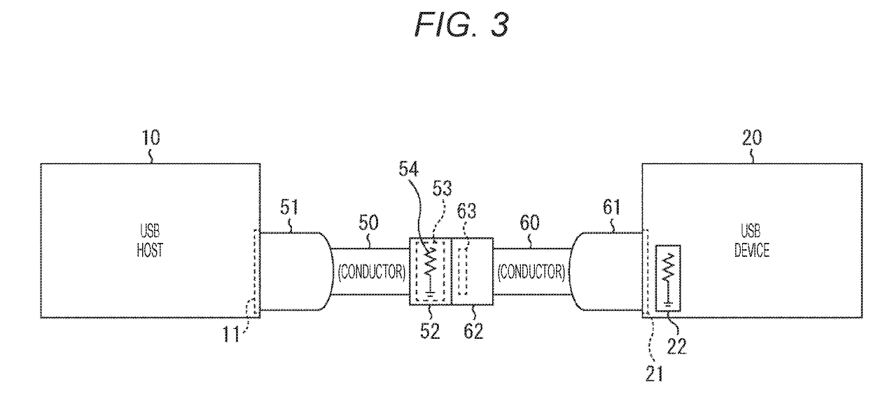

FIG. 3 is a diagram illustrating an example of the configuration of a communication system that transfers data by modulated signals in the millimeter wave band.

Incidentally, the same reference signs are assigned to portions corresponding to the case of FIG. 1 in FIG. 3. A description thereof is omitted below as appropriate.

The communication system of FIG. 3 has the point of including the USB host 10 and the USB device 20 in common with the case of FIG. 1.

However, the communication system of FIG. 3 is different from the case of FIG. 1 in being provided with a millimeter-wave cable 50 and a millimeter-wave cable 60 instead of the USB cable 30. Moreover, the millimeter-wave cable 50 is different from the case of FIG. 1 in including a USB connector 51 and a millimeter-wave connector 52. Furthermore, it is configured in such a manner that the millimeter-wave connector 52 includes a communication unit 53, and the communication unit 53 includes a detected mechanism 54.

Incidentally, it is possible to include the communication unit 53 not in the millimeter-wave connector 52 but in the USB connector 51.

Here, (modulated) signals in the millimeter wave band are signals of frequencies from approximately 30 to 300 GHz, that is, of wavelengths of approximately 1 to 10 mm. With the signals in the millimeter wave band, their high frequencies enable data transfer at high data rates and communication with various waveguides as transmission lines.

In other words, with the signals in the millimeter wave band, it is possible to carry out communication (wireless communication) with free space as a transmission line, using, for example, a small antenna. Moreover, with the signals in the millimeter wave band, communication can be carried out with a metallic cable or a dielectric such as plastic as a transmission line.

The millimeter-wave cable 50 is a cable that is provided at one end with the USB connector 51 that is connected to the USB host 10, and at the other end with the millimeter-wave connector 52 that is fitted to a millimeter-wave connector 62. In the millimeter-wave cable 50, a baseband conductor is employed as the core that connects the USB connector 51 and (the communication unit 53 of) the millimeter-wave connector 52 as in the USB cable 30.

The millimeter-wave connector 52 comprises a material such as a dielectric that serves as a waveguide that transfers modulated signals in the millimeter wave band (radio frequency (RF) signals), and includes the communication unit 53 that communicates by the modulated signals in the millimeter wave band.

The communication unit 53 converts the frequency from differential signals being baseband signals supplied from the USB host 10 via unillustrated data transfer terminals (for example, terminals of + and − signal transmit lines for USB 3.0 in a case of the USB 3.0 specification) of the USB connector 51 to modulated signals in the millimeter wave band, and transmits the modulated signal (to a communication unit 63) via the millimeter-wave connectors 52 and 62 as waveguides.

Moreover, the communication unit 53 receives modulated signals in the millimeter wave band transmitted (from the communication unit 63) via the millimeter-wave connectors 52 and 62 as the waveguides, converts the frequency to baseband signals, and supplies the baseband signals to the USB host 10 via unillustrated data transfer terminals (for example, terminals of + and − signal receive lines for USB 3.0 in the case of the USB 3.0 specification) of the USB connector 51.

The millimeter-wave cable 60 is configured as in the millimeter-wave cable 50.

In other words, the millimeter-wave cable 60 is a cable that is provided at one end with a USB connector 61 that is connected to the USB device 20 and at the other end with the millimeter-wave connector 62 that is fitted to the millimeter-wave connector 52. In the millimeter-wave cable 60, a baseband conductor is employed as the core that connects the USB connector 61 and (the communication unit 63 of) the millimeter-wave connector 62 as in the USB cable 30.

The millimeter-wave connector 62 comprises a material such as a dielectric that serves as a waveguide that transfers modulated signals in the millimeter wave band, and includes the communication unit 63 that communicates by the modulated signals in the millimeter wave band.

The communication unit 63 converts the frequency from differential signals being baseband signals supplied from the USB device 20 via unillustrated data transfer terminals of the USB connector 61 to modulated signals in the millimeter wave band, and transmits the modulated signals (to the communication unit 53) via the millimeter-wave connectors 62 and 52 as the waveguides.

Moreover, the communication unit 63 receives modulated signals in the millimeter wave band transmitted (from the communication unit 53) via the millimeter-wave connectors 52 and 62 as the waveguides, converts the frequency to baseband signals, and supplies the baseband signals to the USB device 20 via unillustrated data transfer terminals of the USB connector 61.

Incidentally, for example, approximately 10 cm to 1 m can be employed as the length of each of the millimeter-wave cables 50 and 60.

In the communication system of FIG. 3 configured as described above, the connections between the USB connectors 11 and 51, between the millimeter-wave connectors 52 and 62, and between the USB connectors 21 and 61 allow data transfer between the USB host 10 and the USB device 20 via the millimeter-wave cables 50 and 60.

In other words, in the communication unit 53, baseband signals as data that is transmitted by the USB host 10 are converted in frequency to modulated signals in the millimeter wave band, and are transmitted.

The modulated signals that are transmitted by the communication unit 53 are received by the communication unit 63, converted in frequency to baseband signals, and supplied to the USB device 20.

On the other hand, in the communication unit 63, baseband signals as data that is transmitted by the USB device 20 are converted in frequency to modulated signals in the millimeter wave band, and are transmitted.

The modulated signals that are transmitted by the communication unit 63 are received by the communication unit 53, converted in frequency to baseband signals, and supplied to the USB host 10.

As described above, in the communication system of FIG. 3, the USB host 10 and the USB device 20, which are electronic devices, are connected not by the USB cable 30 but by the millimeter-wave cables 50 and 60. Data is transferred between the USB host 10 and the USB device 20 via modulated signals in the millimeter wave band. Accordingly, it is possible to increase the variation of modes of connection of electronic devices.

Here, in the communication system of FIG. 3, the millimeter-wave connectors 52 and 62 including the communication units 53 and 63 that transmit and receive modulated signals in the millimeter wave band can comprise a dielectric such as plastic or other nonmetals.

Therefore, with the millimeter-wave connectors 52 and 62, waterproofing and dust proofing measures are easily taken, there is no need to consider the deterioration of contact caused by insertion and removal, and further the degree of freedom in design can be increased, as compared to a connector comprising a metal.

Incidentally, the millimeter-wave connectors 52 and 62 can comprise not a nonmetal but a metal.

Moreover, in FIG. 3, the communication unit 53 is included in the millimeter-wave connector 52. However, the communication unit 53 can be included in, for example, the USB connector 51, other than in the millimeter-wave connector 52.

In a case where the communication unit 53 is included in the USB connector 51, it is required to configure not the baseband conductor but a waveguide that serves as a millimeter-wave transmission line (for example, form a transmission line that guides millimeter waves with, for example, dielectrics having different dielectric constants) between the USB connector 51 and the millimeter-wave connector 52 of the millimeter-wave cable 50.

Similarly, the communication unit 63 can be included not in the millimeter-wave connector 62 but in the USB connector 61. In a case where the communication unit 63 is included in the USB connector 61, again, it is required to configure a waveguide that serves as a millimeter-wave transmission line between the USB connector 61 and the millimeter-wave connector 62 of the millimeter-wave cable 60.

Incidentally, the USB host 10 and the USB device 20 are connected via the communication units 53 and 63 that exchange modulated signals in the millimeter wave band. Hence, even if the USB host 10 and the USB device 20 are connected using the millimeter-wave cables 50 and 60, it is difficult for the USB host 10 to detect the detected mechanism 22 included in the USB device 20.

Then, in a case where the detected mechanism 22 included in the USB device 20 is not detected in the USB host 10, there is a possibility of occurrence of trouble where a connection to the USB device 20 is not recognized (detected) and, even if the USB host 10 and the USB device 20 are connected using the millimeter-wave cables 50 and 60, data transfer (the exchange of baseband signals) is not performed between the USB host 10 and the USB device 20.

The communication unit 53 illustrated in FIG. 3 is configured including the detected mechanism 54 to prevent the occurrence of such trouble. The detected mechanism 54 corresponds to the detected mechanism 22 included in the USB device 20 (has a mechanism similar to the detected mechanism 22) and, when the USB connector 51 is connected to the USB connector 11 of the USB host 10, is (electrically) connected to the USB host 10.

Therefore, as in a case where when being connected to the USB device 20 via the USB cable 30 of FIG. 1, the USB host 10 detects the detected mechanism 22 included in the USB device 20, and recognizes the connection to the USB device 20, when being connected to the millimeter-wave cable 50, the USB host 10 detects the detected mechanism 54 included in the communication unit 53, and recognizes the connection to the USB device 20.

As a result, the USB host 10 is put in a state where data transfer (the exchange of baseband signals) to and from the USB device 20 can be performed. Hence, the communication system of FIG. 3 can solve the trouble that data transfer between the USB host 10 and the USB device 20 cannot be performed.

### <Example of Configurations of Communication Units>

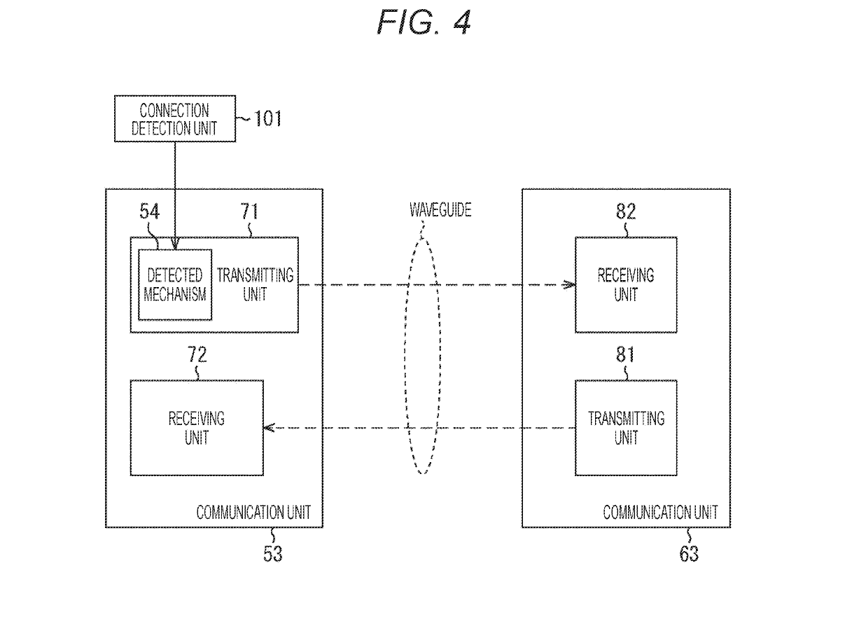

FIG. 4 is a block diagram illustrating an example of the configurations of the communication units 53 and 63 of FIG. 3. The communication unit 53 includes a transmitting unit 71 and a receiving unit 72. The communication unit 63 includes a transmitting unit 81 and a receiving unit 82.

The transmitting unit 71 transmits a signal (data) in, for example, a carrier communication system using a signal in the millimeter wave band as a carrier. In other words, the transmitting unit 71 converts the frequency from a baseband signal (supplied from the USB host 10) to a modulated signal in the millimeter wave band, and transmits the signal (to the receiving unit 82) via the millimeter-wave connectors 52 and 62 (FIG. 3) as the waveguides.

The transmitting unit 71 includes the detected mechanism 54. The detected mechanism 54 is provided on a path where baseband signals are supplied from the USB host 10 to the transmitting unit 71.

Therefore, when the millimeter-wave cable 50 (FIG. 3) (the USB connector 51) is connected to (the USB connector 11 of) the USB host 10, the USB host 10 detects the detected mechanism 54 via the path where baseband signals are supplied to the transmitting unit 71, and recognizes the connection to the USB device 20.

The detected mechanism 54 is controlled by a connection detection unit 101. Although the details are described later, the connection detection unit 101 detects whether or not the millimeter-wave connectors 52 and 62 are connected (whether or not the USB host 10 and the USB device 20 are connected) and, if detecting the connection, supplies a signal indicating the connection (hereinafter described as a connection detection signal) to the detected mechanism 54. The detected mechanism 54 switches the state from OFF to ON in response to the supply of the connection detection signal.

Incidentally, the state where the detected mechanism 54 is ON indicates a state where the USB host 10 can detect the detected mechanism 54. The state where the detected mechanism 54 is OFF indicates a state where the USB host 10 cannot detect the detected mechanism 54.

The connection detection unit 101 is provided in, for example, the millimeter-wave connector 52. Moreover, the connection detection unit 101 may be provided in, for example, part of the communication unit 53. Moreover, the connection detection unit 101 may be provided in the USB host 10.

The connection detection unit 101 detects a connection of the millimeter-wave connectors 52 and 62, for example, electrically. For example, a mechanism is provided which passes a weak current when the millimeter-wave connectors 52 and 62 are connected, and the connection detection unit 101 can be configured in such a manner as to detect whether or not such a current has passed to detect a connection of the millimeter-wave connectors 52 and 62.

Moreover, the connection detection unit 101 detects a connection of the millimeter-wave connectors 52 and 62, for example, magnetically. For example, a mechanism is provided which detects a change in magnetic field when the millimeter-wave connectors 52 and 62 are connected, and the connection detection unit 101 can be configured in such a manner as to detect whether or not there is such a change in magnetic field to detect a connection of the millimeter-wave connectors 52 and 62. Moreover, in a case of such a configuration, it can be configured in such a manner that each of the millimeter-wave connectors 52 and 62 includes a magnet and the magnet connects (holds) the millimeter-wave connectors 52 and 62.

Moreover, the connection detection unit 101 detects a connection of the millimeter-wave connectors 52 and 62, for example, optically. For example, the millimeter-wave connector 52 is provided with a light/dark sensor, and the connection detection unit 101 can be configured in such a manner as to detect a connection to the millimeter-wave connector 62 on the basis of a change in the intensity of light by the light/dark sensor.

Moreover, the connection detection unit 101 detects a connection of the millimeter-wave connectors 52 and 62, for example, physically. For example, the millimeter-wave connector 52 is provided with a button, and the millimeter-wave connector 62 is provided with a protrusion. A mechanism is provided in which when the millimeter-wave connector 62 is connected to the millimeter-wave connector 52, the protrusion of the millimeter-wave connector 62 presses down the button of the millimeter-wave connector 52. The connection detection unit 101 can be configured in such a manner as to detect a connection of the millimeter-wave connectors 52 and 62 when the button is pressed down.

The connection detection unit 101 has such a configuration as described above, and detects a connection of the millimeter-wave connectors 52 and 62. Incidentally, a case where a connection of the millimeter-wave connectors 52 and 62 is detected with a configuration other than the above configuration is also within the scope of application of the present technology.

The receiving unit 72 receives modulated signals in the millimeter wave band transmitted in the carrier communication system, (from the transmitting unit 81) via the millimeter-wave connectors 62 and 52 as the waveguides, converts the frequency from the modulated signals to baseband signals, and outputs the signals (to the USB host 10).

The transmitting unit 81 of the communication unit 63 transmits signals in, for example, a carrier communication system that uses a millimeter-wave signal in the same frequency band as the transmitting unit 71 or a frequency band different from the transmitting unit 71. In other words, the transmitting unit 81 converts the frequency from baseband signals (supplied from the USB device 20) to modulated signals in the millimeter wave band, and transmits the signals (to the receiving unit 72) via the millimeter-wave connectors 62 and 52 as the waveguides.

The receiving unit 82 receives modulated signals in the millimeter wave band transmitted in the carrier communication system, (from the transmitting unit 71) via the millimeter-wave connectors 52 and 62 as the waveguides, converts the frequency from the modulated signals to baseband signals, and outputs the signals (to the USB device 20).

As described above, the communication unit 53 includes the transmitting unit 71 and the receiving unit 72, and the communication unit 63 includes the transmitting unit 81 and the receiving unit 82. Accordingly, two-way communication can be performed between the communication units 53 and 63.

Incidentally, in the case where millimeter-wave signals in the same frequency band are used as carriers in the transmitting units 71 and 81, half-duplex communication can be performed between the communication units 53 and 63. However, even in a case where millimeter-wave signals in the same frequency band are used as carriers in the transmitting units 71 and 81, full-duplex communication can be performed by isolating the transmitting units 71 and 81.

Moreover, in a case where millimeter-wave signals in different frequency bands are used as carriers in the transmitting units 71 and 81, full-duplex communication can be performed between the communication units 53 and 63.

### <Configuration of Transmitting Unit 71>

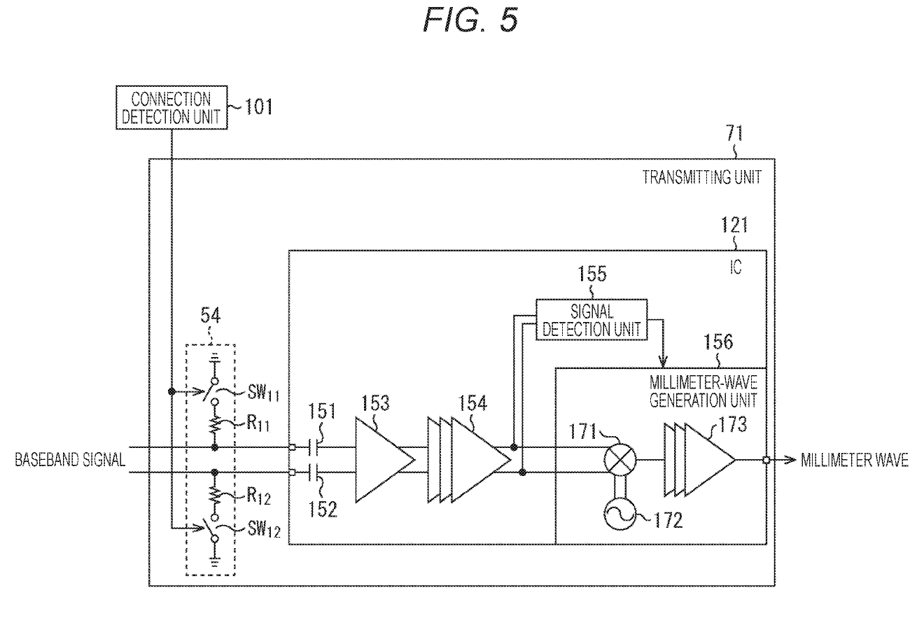

FIG. 5 is a diagram illustrating an example of the configuration of the transmitting unit 71 of FIG. 4.

The transmitting unit 71 is configured including the detected mechanism 54 and an integrated circuit (IC) 121. The detected mechanism 54 includes a switch SW11, a switch SW12, a resistor R11, and a resistor R12. The IC 121 includes a capacitor 151, a capacitor 152, a buffer 153, an amplifier 154, and a millimeter-wave generation unit 156. The millimeter-wave generation unit 156 includes a mixer 171, an oscillator 92, and an amplifier 173.

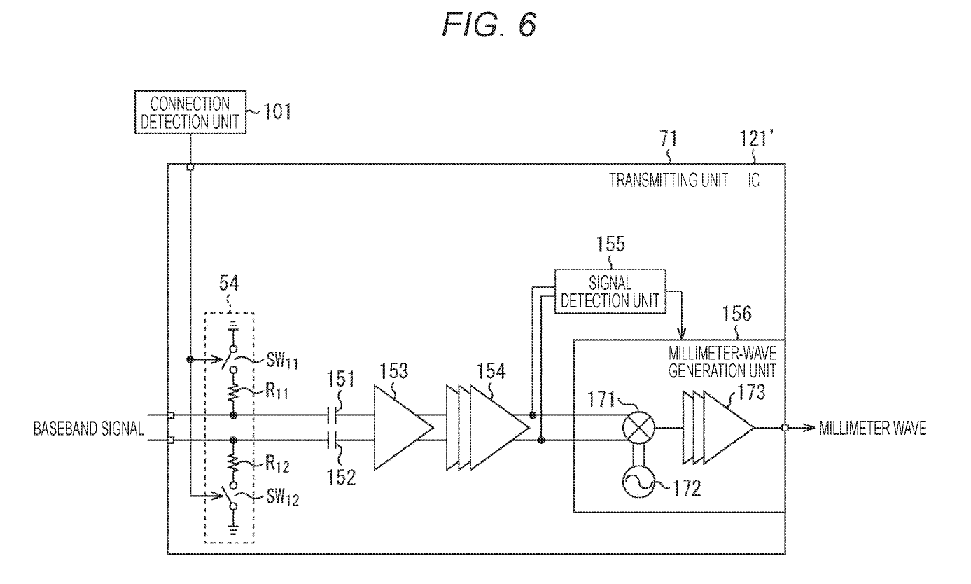

The transmitting unit 71 can also be configured as illustrated in FIG. 6. It is also possible that one IC 121′ configures the transmitting unit 71. In other words, the transmitting unit 71 illustrated in FIG. 5 is configured including the detected mechanism 54 and the IC 121. However, the transmitting unit 71 illustrated in FIG. 6 is configured in such a manner that the detected mechanism 54 is also included in the IC 121′.

As illustrated in FIGS. 5 and 6, the transmitting unit 71 can be configured as one IC, or can be configured including an IC. In the following description, the description is continued taking the transmitting unit 71 illustrated in FIG. 6 as an example.

The detected mechanism 54 is configured including the resistors R11 and R12 as the common-mode impedance employed in the USB 3.0 specification and the USB 3.1 specification.

The resistors R11 and R12 are connected at one end via the buffer 153 to input terminals of the amplifier 154 where a differential signal being a baseband signal is supplied from the USB host 10, respectively, and grounded at the other end via the switches SW11 and SW12, respectively.

Incidentally, it may be configured in such a manner that the other ends of the resistors R11 and R12 are connected to, for example, power supplies of a predetermined voltage, respectively. In the case where the other ends of the resistors R11 and R12 are connected to the power supplies of the predetermined voltage, respectively, it can be configured in such a manner that one of the power supplies connected to the resistors R11 and R12 is, for example, a power supply of a voltage +v (>0), and the other power supply is, for example, a power supply of a voltage −v.

The one end of the resistor R11 is connected via the buffer 153 to the input terminal where a positive signal being one of the differential signals is supplied (inputted) among the two input terminals of the amplifier 154. The other end is grounded via the switch SW11.

The one end of the resistor R12 is connected via the buffer 153 to the input terminal where a negative signal being the other differential signal is supplied (inputted) among the two input terminals of the amplifier 154, and the other end is grounded via the switch SW12.

Here, the negative and positive signals being the differential signals are ideally signals whose values sum to zero.

The turning-on and -off of each of the switches SW11 and SW12 is controlled by a connection detection signal from the connection detection unit 101. Specifically, when the connection detection unit 101 supplies a connection detection signal indicating a connection of the millimeter-wave connectors 52 and 62 (a connection of devices), both of the switches SW11 and SW12 are turned on.

For example, it may be configured in such a manner that the connection detection unit 101 outputs a connection detection signal at predetermined intervals while the connection continues being detected, and the switches SW11 and SW12 stay on while the connection detection signal continues being outputted.

Moreover, for example, it may be configured in such a manner that the connection detection unit 101 outputs a connection detection signal only when detecting a connection or only when detecting a disconnection, and the ON or OFF state of the switches SW11 and SW12 can be switched to the OFF or ON state when a connection detection signal is issued.

In the transmitting unit 71 configured as described above, when the millimeter-wave cable 50 (FIG. 3) is connected to the USB host 10, the USB host 10 detects the resistors R11 and R12 as the common-mode impedance configuring the detected mechanism 54 connected to the input terminals of the amplifier 154.

Consequently, the USB host 10 recognizes a connection to the USB device 20, and starts outputting baseband signals.

When the detected mechanism 54 is put in the ON state, differential signals (for example, signals of + and − signal transmit lines for USB 3.0 in a case of USB 3.0) being baseband signals are supplied from the USB host 10 to the amplifier 154 via the capacitors 151 and 152 and the buffer 153.

Moreover, the baseband signals outputted from the amplifier 154 are also supplied to a signal detection unit 155. The signal detection unit 155 detects the supply of the signals, for example, in a case where a difference between the supplied baseband signals (differential signals) is equal to or greater than a predetermined value. In a case where the signal detection unit 155 detects the signals, the millimeter-wave generation unit 156 starts generating millimeter waves.

In other words, the millimeter-wave generation unit 156 is put in the ON state while the signal detection unit 155 continues detecting the signals, and the millimeter-wave generation unit 156 is put in the OFF state when the signal detection unit 155 does not detect the signals.

When the millimeter-wave generation unit 156 is in the ON state, the amplifier 154 of the millimeter-wave generation unit 156 amplifies the differential signals if necessary, and supplies the signals to the mixer 171 in the millimeter-wave generation unit 156.

The oscillator 172 generates a carrier in a millimeter wave band of, for example, 60 GHz by oscillation and supplies the carrier to the mixer 171.

Here, with a carrier in a millimeter wave band of, for example, 60 GHz, a differential signal with a data rate of, for example, approximately 10 Gbps at the maximum can be transmitted. For example, in USB 3.0, the maximum data rate is 5 giga bit per second (Gbps). Accordingly, with a carrier in a millimeter wave band of, for example, 60 GHz, data (differential signals) of USB 3.0 can be transmitted without problems.

The mixer 171 mixes (multiplies) the differential signals from the amplifier 154 and the carrier from the oscillator 172, and accordingly converts the differential signals in frequency with the carrier from the oscillator 172. The mixer 171 supplies, to the amplifier 173, a resultant modulated signal in the millimeter wave band by, for example, amplitude-shift keying (amplitude shift keying (ASK)).

The amplifier 173 amplifies the modulated signal from the mixer 171 if necessary, and outputs (transmits) the signal to (the millimeter-wave connector 52 as) the waveguide. The receiving unit 82 receives the signal modulated in this manner.

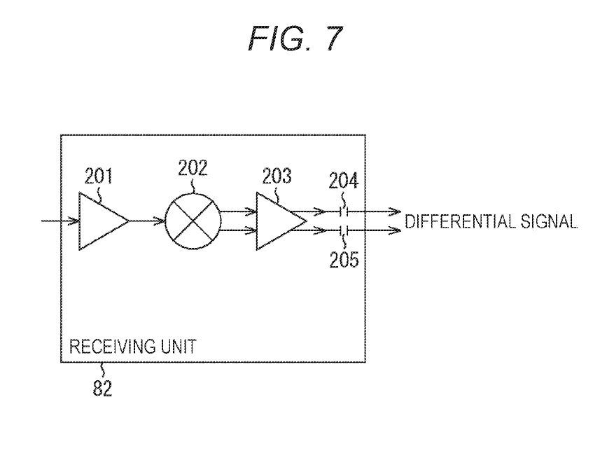

The receiving unit 82 has such a configuration as illustrated in FIG. 7. In other words, the receiving unit 82 includes an amplifier 201, a mixer 202, an amplifier 203, a capacitor 204, and a capacitor 205.

The amplifier 201 receives the modulated signal in the millimeter wave band transmitted from the transmitting unit 71 via (the millimeter-wave connectors 52 and 62 as) the waveguides, amplifies the signal if necessary, and supplies the signal to the mixer 202.

The mixer 202 performs square-law detection that mixes the modulated signals in the millimeter wave band supplied from the amplifier 201 (squares the modulated signal). Accordingly, the mixer 202 converts the frequency from the modulated signal in the millimeter waveband from the amplifier 201 to differential signals being baseband signals, and supplies the signals to the amplifier 203.

The amplifier 203 amplifies the differential signals from the mixer 202 if necessary, and supplies the signals as USB differential signals (for example, signals of + and − signal transmit lines for USB 3.0 in a case of USB 3.0) to the USB device 20.

Incidentally, one (hereinafter also referred to as a positive signal) of the two (baseband) signals as the differential signals obtained in the amplifier 203 is supplied to the USB device 20 via the capacitor 204. The other signal (hereinafter also referred to as a negative signal) is supplied to the USB device 20 via the capacitor 205. A direct current component is cut off in the capacitors 204 and 205.

Moreover, it is configured in FIG. 7 in such a manner that a modulated signal in the millimeter wave band is converted in frequency to a baseband signal by square-law detection in the receiving unit 82. However, in addition, in the receiving unit 82, for example, a modulated signal can be converted in frequency to a baseband signal by detection such as synchronous detection where a carrier is recovered to mix the carrier and the modulated signal, other than the square-law detection.

The receiving unit 72 (FIG. 4) of the communication unit 53) can be configured similarly to the receiving unit 82, which is illustrated in FIG. 7, of the communication unit 63. Accordingly, a description thereof is omitted here.

The transmitting unit 81 of the communication unit 63 can be configured similarly to the transmitting unit 71, which is illustrated in FIG. 6, of the communication unit 53, or configured in such a manner that the detected mechanism 54 is omitted. Accordingly, a description thereof is omitted here.

In the transmitting unit 71 and the receiving unit 72, and the transmitting unit 81 and the receiving unit 82, which are configured as described above, the transmitting unit 71 transmits a modulated signal in the millimeter wave band, and the receiving unit 82 receives the modulated signal, and accordingly, a baseband signal is transferred from the USB host 10 to the USB device 20.

### <Regarding Operation of Transmitting Unit 71>

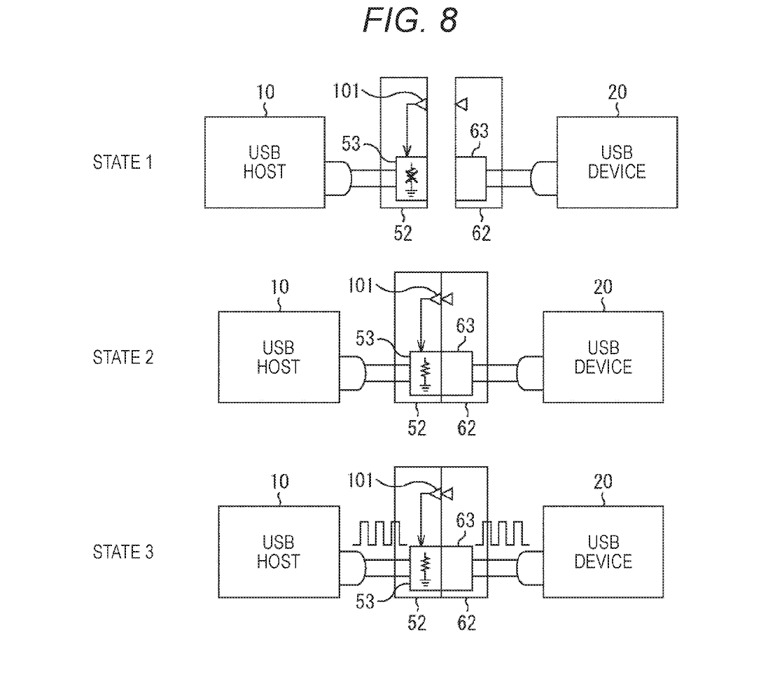

A change in the operation of the transmitting unit 71 is described with reference to FIG. 8. A top diagram of FIG. 8 represents a state (let the state be state 1) of the communication unit 53 (the transmitting unit 71 in the communication unit 53) at the time when the millimeter-wave connectors 52 and 62 are not connected. A middle diagram represents a state (let the state be state 2) of the transmitting unit 71 immediately after the millimeter-wave connectors 52 and 62 are connected. A bottom diagram represents a state (let the state be state 3) of the transmitting unit 71 at the time when the millimeter-wave connectors 52 and 62 are connected.

With reference to the top diagram of FIG. 8, state 1 is a state at the time when the millimeter-wave connectors 52 and 62 are not connected. Accordingly, the connection detection unit 101 is in a state of detecting no connection of the millimeter-wave connectors 52 and 62.

Moreover, when in state 1, the connection detection unit 101 is in the state of detecting no connection. Accordingly, the detected mechanism 54 is in the OFF state. Accordingly, it is a state where no baseband signal is supplied from the USB host 10. Moreover, when in state 1, it is the state where no baseband signal is supplied from the USB host 10. Accordingly, the signal detection unit 155 is in a state of detecting no signal.

Furthermore, when in state 1, the signal detection unit 155 is in the state of detecting no signal. Accordingly, the millimeter-wave generation unit 156 is in a state of being OFF and in a state of outputting no millimeter wave.

In this manner, in the case of state 1 where the millimeter-wave connectors 52 and 62 are not connected, a millimeter wave is not outputted. Hence, it is possible to prevent a millimeter wave from being outputted unnecessarily when the millimeter-wave connectors 52 and 62 are not connected. In other words, unwanted emissions can be reduced.

Moreover, in a case of a configuration where a millimeter wave is outputted also when the millimeter-wave connectors 52 and 62 are not connected, that is, in a case where there is unintentional radiation (unintentional radiator), restrictions that the level of the unintentional radiation is reduced to or below a predetermined value and commercialization is not allowed without approval from a predetermined organization may be imposed.

However, according to the present technology, as described above, unwanted emissions can be reduced (eliminated). In other words, when in the state where the millimeter-wave connectors 52 and 62 are not connected, it is controlled to prevent the output of a millimeter wave. Accordingly, there is no unintentional radiation, and there is no need to obtain approval from a predetermined organization, either.

Furthermore, when in the state where the millimeter-wave connectors 52 and 62 are not connected, the millimeter-wave generation unit 156 is put in the OFF state. Accordingly, the power consumed by the millimeter-wave generation unit 156 can be reduced. Hence, the effect of reducing power consumption can also be expected with application of the present technology.

Furthermore, according to the present technology, the state changes as described below. Accordingly, the occurrence of trouble that data cannot be transferred between the USB host 10 and the USB device 20 can also be prevented.

In state 2, the detected mechanism 54 is put in the ON state. With reference to the middle diagram of FIG. 8, state 2 is a state where the millimeter-wave connectors 52 and 62 are connected and the connection detection unit 101 has detected the connection of the millimeter-wave connectors 52 and 62.

Moreover, when in state 2, the connection detection unit 101 is in the state of having detected the connection. Accordingly, the detected mechanism 54 is switched from the OFF state to the ON state. In other words, the switches SW11 and SW12 are closed. When the detected mechanism 54 is turned on, the USB host 10 enters a state of being able to detect the detected mechanism 54.

When in state 2, the USB host 10 is in a state of supplying no baseband signal. Moreover, since, when in state 2, the USB host 10 is in the state of supplying no baseband signal, the signal detection unit 155 is in a state of detecting no signal.

Furthermore, when in state 2, the signal detection unit 155 is in the state of detecting no signal. Accordingly, the millimeter-wave generation unit 156 is in the OFF state, and in a state of outputting no millimeter wave.

In this manner, in a case of state 2 immediately after the millimeter-wave connectors 52 and 62 are connected, a millimeter wave is not outputted. Accordingly, it is possible to prevent a millimeter wave from being outputted unnecessarily when communication is not started yet. Hence, the above effect can be obtained.

Furthermore, when the detected mechanism 54 is turned on, the USB host 10 enters the state of being able to detect the detected mechanism 54. Accordingly, the state of the transmitting unit 71 shifts to state 3. State 3 is a state where a connection of the millimeter-wave connectors 52 and 62 has been established and the USB host 10 is outputting a baseband signal.

When in state 3, the connection detection unit 101 is in a state of continuing detecting the connection. Accordingly, the detected mechanism 54 stays ON. In other words, the switches SW11 and SW12 stay closed. Moreover, when in state 3, the USB host 10 is in the state of outputting a baseband signal in response to the detection of the detected mechanism 54.

Moreover, when in state 2, the USB host 10 is in the state of supplying a baseband signal. Accordingly, the signal detection unit 155 enters a state of having detected the signal. When in state 3, the signal detection unit 155 is in the state of detecting the signal. Accordingly, the millimeter-wave generation unit 156 is turned on to enter a state of outputting a millimeter wave.

In this manner, only in the case of state 3 where the millimeter-wave connectors 52 and 62 are connected, and a baseband signal is being supplied, a millimeter wave is outputted. Hence, it is possible to prevent a millimeter wave from being outputted unnecessarily when the millimeter-wave connectors 52 and 62 are not connected, or when a baseband signal is not outputted, in other words, when communication is not performed. Hence, the above effect can be obtained.

Moreover, the presence of the detected mechanism 54 enables the USB host 10 to detect a connection of the millimeter-wave connectors 52 and 62. Accordingly, it is also possible to prevent the occurrence of trouble that data cannot be transferred between the USB host 10 and the USB device 20.

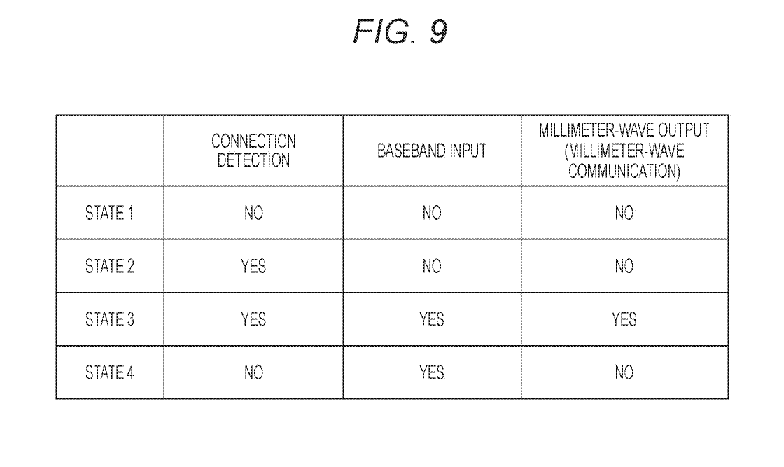

A table illustrated in FIG. 9 provides a summary of states 1, 2, and 3 that have been described up to this point.

State 1 is the state where the detection of a connection of the USB host 10 and the USB device 20 (the detection of a connection of the millimeter-wave connectors 52 and 62) does not occur, is the state where there is no input of a baseband signal to the transmitting unit 71, and is the state where there is no output of a millimeter wave from the transmitting unit 71 (millimeter-wave communication is not being performed). Such a state 1 is a state where the devices are not connected and an unwanted millimeter wave is not outputted.

State 2 is the state where the detection of a connection of the USB host 10 and the USB device 20 (the detection of a connection of the millimeter-wave connectors 52 and 62) occurs, is the state where there is no input of a baseband signal to the transmitting unit 71, and is the state where there is no output of a millimeter wave from the transmitting unit 71 (millimeter-wave communication is not being performed). Such a state 2 is a state where the devices are connected, but there is no baseband input, and an unnecessary millimeter wave is not outputted.

State 3 is the state where the detection of a connection of the USB host 10 and the USB device 20 (the detection of a connection of the millimeter-wave connectors 52 and 62) occurs, is the state where there is an input of a baseband signal to the transmitting unit 71, and the state where there is an output of a millimeter wave from the transmitting unit 71 (millimeter-wave communication is being performed). Such a state 3 is a state where the devices are connected, there is a baseband input, and millimeter-wave communication can be performed.

Furthermore, in terms of the state, it is also assumed to enter state 4. State 4 is a state where the detection of a connection of the USB host 10 and the USB device 20 (the detection of a connection of the millimeter-wave connectors 52 and 62) does not occur, is a state where there is an input of a baseband signal to the transmitting unit 71, and is a state where there is no output of a millimeter wave from the transmitting unit 71 (millimeter-wave communication is not being performed). Such a state 4 is a state where there is a baseband input, but the devices are not connected, and an unnecessary millimeter wave is not generated.

Since the devices are not connected, the connection detection unit 101 is in the state of detecting no connection. Although the detected mechanism 54 is in the OFF state, it is in a state where there is an input of a baseband signal. Accordingly, it is considered to be a state where some error is occurring.

Moreover, it is the state where regardless of that a baseband signal is being inputted to the transmitting unit 71, the millimeter-wave generation unit 156 does not generate a millimeter wave. Accordingly, also in this respect, it is considered to be the state where some error is occurring.

Moreover, in a case where a state like state 4 occurs, since a baseband signal is being inputted to the transmitting unit 71, the presence of a signal may be detected by the signal detection unit 155, and the millimeter-wave generation unit 156 may enter the ON state to output a millimeter wave. This state (not illustrated, but state 5) is a state where the devices are not connected, but a baseband signal is supplied, and a millimeter wave is outputted. Also in this respect, it is considered to be the state where some error is occurring.

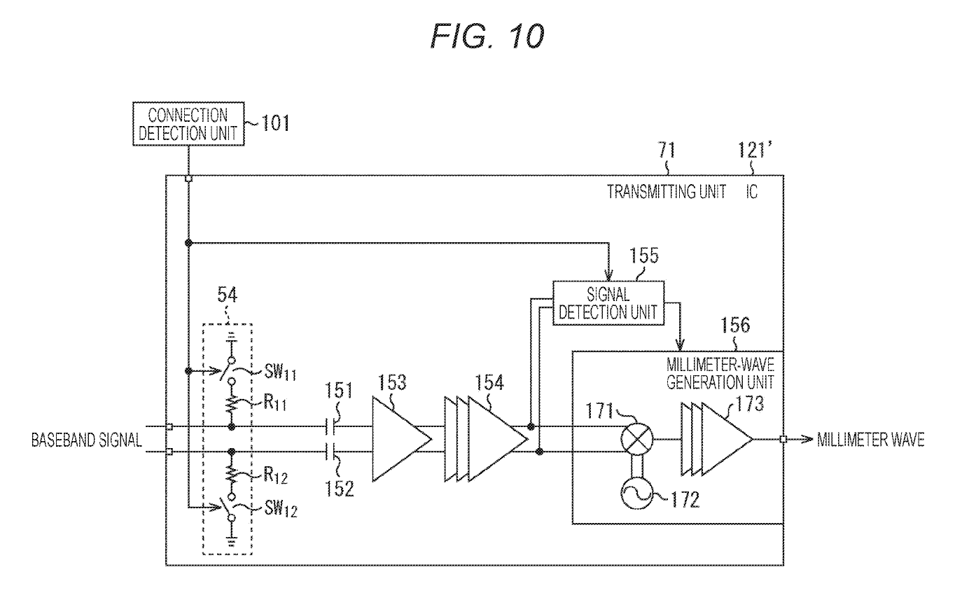

Hence, in order to prevent the occurrence of such an error, the transmitting unit 71 may be configured as illustrated in FIG. 10 to further ensure control to output a millimeter wave only when the devices are connected.

The transmitting unit 71 illustrated in FIG. 10 has the same configuration as the transmitting unit 71 illustrated in FIG. 6 except a point that it is configured in such a manner that a signal from the connection detection unit 101 is also supplied to the signal detection unit 155 as compared to the transmitting unit 71 illustrated in FIG. 6.

According to the configuration of the transmitting unit 71 illustrated in FIG. 10, the connection detection unit 101 supplies a signal indicating a connection of the millimeter-wave connectors 52 and 62 (a connection detection signal indicating a connection of the devices) to the switches SW11 and SW12 and the signal detection unit 155. The connection detection signal is supplied to the switches SW11 and SW12 to put the switches SW11 and SW12 in the ON state and put the detected mechanism 54 in the ON state as in the above case.

Furthermore, the connection detection signal is supplied to the signal detection unit 155. Accordingly, the signal detection unit 155 can detect a connection of the devices. When detecting a connection of the devices, and when detecting an input of a baseband signal via the amplifier 154, the signal detection unit 155 puts the millimeter-wave generation unit 156 in the ON state to put the millimeter-wave generation unit 156 in the state of outputting a millimeter wave.

In this manner, the signal detection unit 155 puts the millimeter-wave generation unit 156 in the ON state only when detecting both of the detection of the devices and the detection of a baseband signal. In this manner, the signal detection unit 155 controls the turning-on and -off of the millimeter-wave generation unit 156. Accordingly, it becomes possible to perform control in such a manner as to prevent the output of a millimeter wave even in a state like state 4 (a state where an error is occurring).

For example, in a case where, like state 4, a state where the devices are not connected but a baseband signal is being inputted occurs, since the devices are in the state of not being connected, the connection detection unit 101 does not output a connection detection signal. Then, even if being supplied a baseband signal from the amplifier 154, the signal detection unit 155 is in a state of being supplied with no connection detection signal and, accordingly, continues the OFF state of the millimeter-wave generation unit 156 and does not perform control to turn the millimeter-wave generation unit 156 on. Hence, even if a state like state 4 occurs, the state of outputting a millimeter wave does not occur.

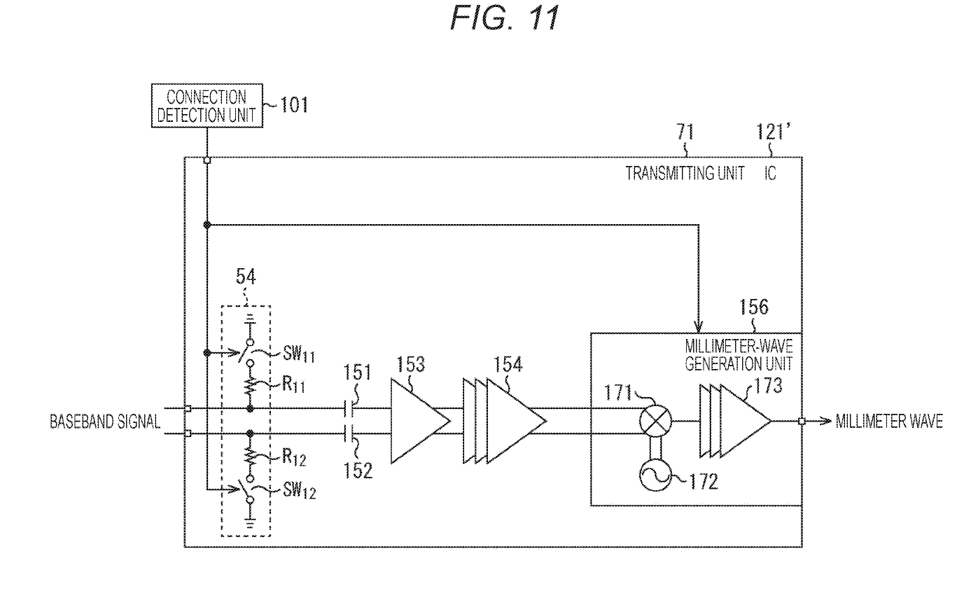

Incidentally, in terms of the transmitting unit 71 illustrated in FIG. 10, the configuration is illustrated in which the signal detection unit 155 is provided to control the turning-on and -off of the millimeter-wave generation unit 156. However, as illustrated in FIG. 11, it is also possible to have a configuration where the signal detection unit 155 is not provided and the turning-on and -off of the millimeter-wave generation unit 156 is controlled directly by a connection detection signal.

The transmitting unit 71 illustrated in FIG. 11 has the same configuration as the transmitting unit 71 illustrated in FIG. 6 except a point that it is configured in such a manner that the signal detection unit 155 has been removed from the transmitting unit 71 illustrated in FIG. 6, and a signal from the connection detection unit 101 is also supplied to the millimeter-wave generation unit 156.

According to the configuration of the transmitting unit 71 illustrated in FIG. 11, the connection detection unit 101 supplies a connection detection signal to the switches SW11 and SW12 and the millimeter-wave generation unit 156. The connection detection signal is supplied to the switches SW11 and SW12 to put both of the switches SW11 and SW12 in the ON state and put the detected mechanism 54 in the ON state, as in the above case.

Furthermore, when the connection detection signal is supplied to the millimeter-wave generation unit 156, the millimeter-wave generation unit 156 enters the ON state to enter the state of outputting a millimeter wave. In other words, in this case, the millimeter-wave generation unit 156 is configured in such a manner that turning-on and -off is controlled by a connection detection signal from the connection detection unit 101.

In this manner, in a case where the millimeter-wave generation unit 156 is controlled by a connection detection signal from the connection detection unit 101, even if, for example, a state where the devices are not connected but a baseband signal is being inputted, like state 4, occurs, the devices are in the state of not being connected, and accordingly, the connection detection unit 101 does not output a connection detection signal, and the millimeter-wave generation unit 156 stays OFF. Hence, even if a state like state 4 occurs, the state of outputting a millimeter wave does not occur.

Incidentally, FIGS. 10 and 11 illustrate the case where an application is made to the transmitting unit 71 illustrated in FIG. 6. However, an application can also be made to the transmitting unit 71 illustrated in FIG. 5.

### <Regarding Operation of Transmitting Unit 71>

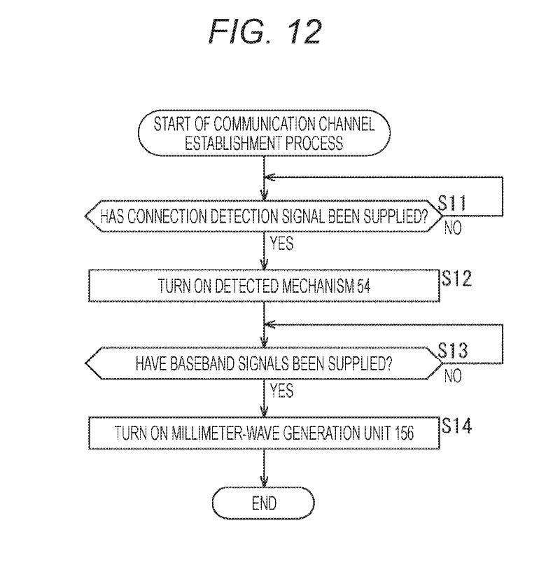

Next, the operation of the transmitting unit 71 is described with reference to a flowchart of FIG. 12. Incidentally, here, a description is continued assuming the operation of the transmitting unit 71 illustrated in FIG. 6. However, the operation is also basically similar in the transmitting units 71 illustrated in FIGS. 5, 10, and 11.

In step S11, the transmitting unit 71 determines whether or not the connection detection unit 101 has supplied a connection detection signal. In step S11, the determination in step S11 is repeated until it is determined that a connection detection signal has been supplied. This state is state 1 described with reference to FIGS. 8 and 9. In other words, it is the state where there is neither an input of a baseband signal nor an output of a millimeter wave.

In step S11, in a case where it is determined that a connection detection signal has been supplied (it is determined that the devices are connected), the process proceeds to step S12. In step S12, both of the switches SW11 and SW12 in the detected mechanism 54 are put in the ON state (closed) to put the detected mechanism 54 in the ON state. In other words, the detected mechanism 54 and the USB host 10 are put in the state of being connected to allow the USB host 10 to detect the detected mechanism 54.

This state is state 2 described with reference to FIGS. 8 and 9. In other words, it is a state where although a connection of the devices has been detected, there is neither an input of a baseband signal nor an output of a millimeter wave.

In step S13, it is determined whether or not a baseband signal has been supplied from the USB host 10. In step S13, the determination in step S13 is repeated until it is determined that a baseband signal has been supplied.

In step S13, in a case where it is determined that a baseband signal has been supplied, the process proceeds to step S14. In step S14, the millimeter-wave generation unit 156 is turned on to start outputting a millimeter wave.

The supply of a baseband signal allows the signal detection unit 155 to detect the supply of a baseband signal and put the millimeter-wave generation unit 156 in the ON state. The millimeter-wave generation unit 156 is turned on. Accordingly, the millimeter-wave generation unit 156 converts the supplied baseband signal to a millimeter wave and outputs the millimeter wave.

In this manner, a communication channel between the USB host 10 and the USB device 20 is established.

After the communication channel is established in this manner, communication using the millimeter wave is performed between the USB host 10 and the USB device 20. Then, in a case where the USB host 10 and the USB device 20 are disconnected, the output of a millimeter wave from the millimeter-wave generation unit 156 is stopped.

In other words, when the USB host 10 and the USB device 20 are disconnected first, then the connection detection unit 101 detects the disconnection, and the switches SW11 and SW12 in the detected mechanism 54 are opened (turned off).

The detected mechanism 54 is turned off. Accordingly, the USB host 10 enters a state of being unable to detect the detected mechanism 54, and accordingly, stops outputting a baseband signal. When the supply of a baseband signal from the USB host 10 is stopped, the signal detection unit 155 determines that no signal is detected, and returns the millimeter-wave generation unit 156 back to the OFF state. The millimeter-wave generation unit 156 is turned off to stop the output of a millimeter wave from the millimeter-wave generation unit 156.

Hence, even in a case where the connected device is removed, it is possible to perform control in such a manner as to prevent the output of a millimeter wave.

According to the present technology, when the devices are not connected (when the millimeter-wave connectors 52 and 62 are not connected), it is possible to prevent a millimeter wave from being outputted unnecessarily and reduce unwanted emissions.

Moreover, when in the state where the millimeter-wave connectors 52 and 62 are not connected, the millimeter-wave generation unit 156 is put in the OFF state. Accordingly, the power consumed by the millimeter-wave generation unit 156 can be reduced. Hence, the effect of reducing power consumption can also be expected.

Furthermore, according to the present technology, it is also possible to prevent the occurrence of trouble that data cannot be transferred between the USB host 10 and the USB device 20.

### <Other Embodiments of Communication System Where Present Technology Is Applied>

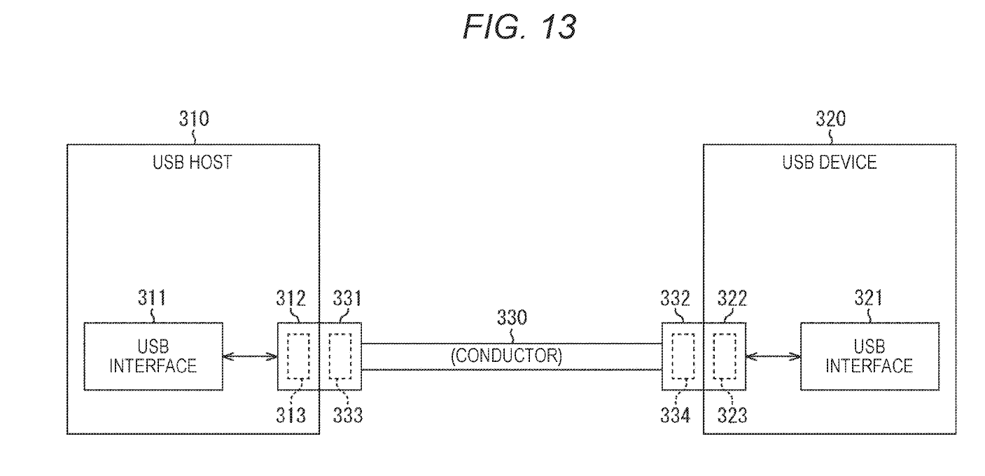

FIG. 13 is a diagram illustrating another example of the configuration of the communication system where the present technology is applied.

In the communication system of FIG. 13, a USB host 310 and a USB device 320 are connected by a millimeter-wave capable electrical cable 330.

The USB host 310 is an electronic device having a function to be a USB host as in the USB host 10, and includes a USB interface 311 and a millimeter-wave connector 312.

The USB interface 311 is an interface that controls data transfer by USB, and is connected to (a communication unit 313 included in) the millimeter-wave connector 312.

The millimeter-wave connector 312 comprises a material such as a dielectric that serves as a waveguide that transfers a modulated signal in the millimeter wave band as in the millimeter-wave connectors 52 and 62 (FIG. 3), and includes the communication unit 313.

The communication unit 313 is configured as in the communication unit 53 (FIG. 3), and transmits and receives baseband signals to and from the USB interface 311, and transmits and receives modulated signals in the millimeter wave band to and from a communication unit 333 via the millimeter-wave connector 312 and a millimeter-wave connector 331 as waveguides.

The USB device 320 is an electronic device having a function to be a USB device as in the USB device 20, and includes a USB interface 321 and a millimeter-wave connector 322.

The USB interface 321 is an interface that controls data transfer by USB, and is connected to (a communication unit 323 included in) the millimeter-wave connector 322.

The millimeter-wave connector 312 comprises a material such as a dielectric that serves as a waveguide that transfers a modulated signal in the millimeter wave band as in the millimeter-wave connectors 52 and 62 (FIG. 3), and includes the communication unit 323.

The communication unit 323 is configured as in, for example, the communication unit 63 (FIG. 3), and transmits and receives baseband signals to and from the USB interface 321 and transmits and receives modulated signals in the millimeter wave band to and from a communication unit 334 via the millimeter-wave connector 322 and a millimeter-wave connector 332 as waveguides.

The millimeter-wave capable electrical cable 330 is a cable that is provided at one end with the millimeter-wave connector 331 that is fitted to the millimeter-wave connector 312 of the USB host 310, and at the other end with the millimeter-wave connector 332 that is fitted to the millimeter-wave connector 322 of the USB device 320, the core of the cable being a conductor.

The millimeter-wave connectors 331 and 332 comprise a material such as a dielectric that serves as a waveguide that transfers modulated signals in the millimeter wave band as in the millimeter-wave connectors 52 and 62 (FIG. 3). In addition, the millimeter-wave connector 331 includes the communication unit 333. The millimeter-wave connector 332 includes the communication unit 334.

The communication unit 333 is configured as in, for example, the communication unit 63 (FIG. 3), and transmits and receives modulated signals in the millimeter wave band to and from the communication unit 313 via the millimeter-wave connectors 331 and 312 as the waveguides, and transmits and receives baseband signals to and from the communication unit 334 via the conductor as the core of the millimeter-wave capable electrical cable 330.

The communication unit 334 is configured as in, for example, the communication unit 53 (FIG. 3), and transmits and receives modulated signals in the millimeter wave band to and from the communication unit 323 via the millimeter-wave connectors 332 and 322 as the waveguides, and transmits and receives baseband signals to and from the communication unit 333 via the conductor as the core of the millimeter-wave capable electrical cable 330.

In FIG. 13, the millimeter-wave connector 331 of the millimeter-wave capable electrical cable 330 is connected to the millimeter-wave connector 312 of the USB host 310, and the millimeter-wave connector 332 of the millimeter-wave capable electrical cable 330 is connected to the millimeter-wave connector 322 of the USB device 320. Accordingly, the USB host 310 and the USB device 320 are connected via the millimeter-wave capable electrical cable 330.

Then, the exchange of modulated signals between the communication units 313 and 333, the exchange of baseband signals between the communication units 333 and 334, and the exchange of modulated signals between the communication units 334 and 323 can be carried out. Accordingly, data is transferred by the baseband signals between the USB interface 311 of the USB host 310 and the USB interface 321 of the USB device 320.

In FIG. 13, the millimeter-wave connectors 312, 322, 331, and 332 can comprise nonmetals as in the millimeter-wave connectors 52 and 62. In this case, as compared to a connector comprising a metal, waterproofing and dust proofing measures are easily taken, there is no need to consider the deterioration of contact caused by insertion and removal, and further the degree of freedom in design can be increased.

Here, in the communication system of FIG. 3, it is necessary to connect the USB host 10 and the USB device 20 by two cables, the millimeter-wave cables 50 and 60, to transfer data between the USB host 10 and the USB device 20.

However, in the communication system of FIG. 3, it is not necessary to provide the USB host 10 and the USB device 20 with a millimeter-wave connector like the millimeter-wave connectors 312 and 322 as in the case of FIG. 13.

On the other hand, in the communication system of FIG. 13, it is necessary to provide the millimeter-wave connector 312 to the USB host 310 and provide the millimeter-wave connector 322 to the USB device 320.

However, in the communication system of FIG. 13, the USB host 310 and the USB device 320 can be connected by one cable, the millimeter-wave capable electrical cable 330, to transfer data between the USB host 310 and the USB device 320.

Furthermore, in the communication system of FIG. 13, it is possible to enjoy advantages such as waterproofing and dust proofing measures being easily taken at both of the connection portion between the USB host 310 and the millimeter-wave capable electrical cable 330 and the connection portion between the USB device 320 and the millimeter-wave capable electrical cable 330.

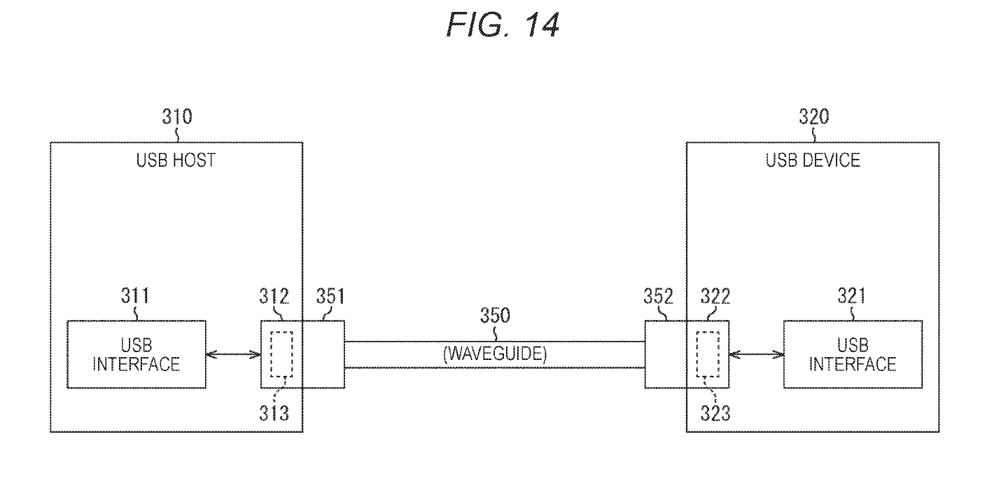

FIG. 14 is a diagram illustrating another example of the configuration of the communication system where the present technology is applied.

In FIG. 14, the same reference signs are assigned to portions corresponding to the case of FIG. 13, and a description thereof is omitted as appropriate below.

The communication system of FIG. 14 has the point of including the USB host 310 and the USB device 320 in common with the case of FIG. 13, but is different from the case of FIG. 13 in being provided with a millimeter-wave transfer-purpose cable 350 instead of the millimeter-wave capable electrical cable 330

The millimeter-wave transfer-purpose cable 350 is a cable whose core is a waveguide that transfers modulated signals in the millimeter wave band, and is provided at one end with a millimeter-wave connector 351 that is fitted to the millimeter-wave connector 312 of the USB host 310 and at the other end with a millimeter-wave connector 352 that is fitted to the millimeter-wave connector 322 of the USB device 320.

The millimeter-wave connectors 351 and 352 comprise a material such as a dielectric that serves as a waveguide that transfers modulated signals in the millimeter wave band as in the millimeter-wave connectors 52 and 62 (FIG. 3).

Therefore, the entire millimeter-wave transfer-purpose cable 350 (from the millimeter-wave connector 351 to the millimeter-wave connector 352) is a waveguide that transfers modulated signals in the millimeter wave band.

In FIG. 14, the millimeter-wave connector 351 of the millimeter-wave transfer-purpose cable 350 is connected to the millimeter-wave connector 312 of the USB host 310, and the millimeter-wave connector 352 of the millimeter-wave transfer-purpose cable 350 is connected to the millimeter-wave connector 322 of the USB device 320. Accordingly, the USB host 310 and the USB device 320 are connected via the millimeter-wave transfer-purpose cable 350.

Modulated signals in the millimeter wave band are exchanged between the communication units 313 and 323 via the millimeter-wave transfer-purpose cable 350 as the waveguide. Accordingly, data is transferred by baseband signals between the USB interface 311 of the USB host 310 and the USB interface 321 of the USB device 320.

The communication system of FIG. 14 can also enjoy an effect similar to the case of FIG. 13.

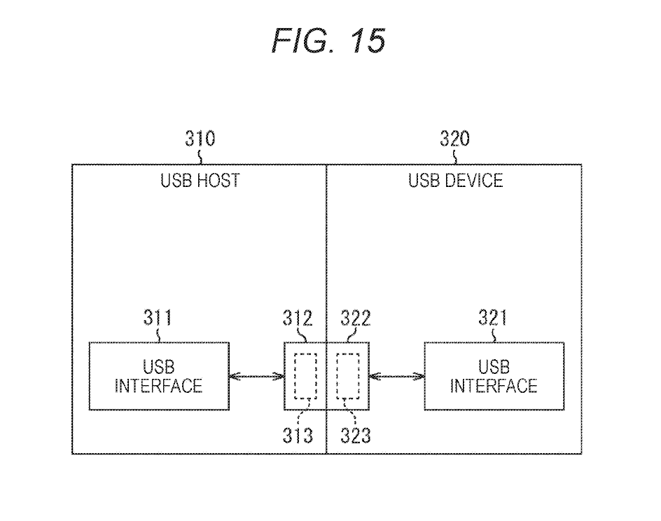

FIG. 15 is a diagram illustrating another example of the configuration of the communication system where the present technology is applied.

Incidentally, in FIG. 15, the same reference signs are assigned to portions corresponding to the case of FIG. 13. A description thereof is omitted as appropriate below.

The communication system of FIG. 15 has the point of including the USB host 310 and the USB device 320 in common with the case of FIG. 13, but is different from the case of FIG. 13 in not being provided with the millimeter-wave capable electrical cable 330.

The millimeter-wave connector 312 of the USB host 310 and the millimeter-wave connector 322 of the USB device 320 can also be configured to be fitted directly to each other, in addition to being fitted to the millimeter-wave connectors 331 and 332 of the millimeter-wave capable electrical cable 330 (or the millimeter-wave connectors 351 and 352 of the millimeter-wave transfer-purpose cable 350), respectively.

In FIG. 15, for example, as in a case where a USB memory as a USB device is connected directly to a personal computer (PC) as a USB host, the millimeter-wave connector 312 of the USB host 310 and the millimeter-wave connector 322 of the USB device 320 are connected directly.

Then, modulated signals in the millimeter wave band are exchanged between the communication unit 313 included in the millimeter-wave connector 312 and the communication unit 323 included in the millimeter-wave connector 322 via the millimeter-wave connectors 312 and 322 as the waveguides to transfer data by baseband signals between the USB interface 311 of the USB host 310 and the USB interface 321 of the USB device 320.

The communication system of FIG. 15 can also enjoy an effect similar to the case of FIG. 13.

Incidentally, the embodiments of the present technology are not limited to the above-mentioned embodiments, and can be modified in various manners within the scope that does not depart from the gist of the present technology.

For example, in the embodiments, signals in the millimeter wave band are employed as modulated signals. However, signals in frequency bands lower or higher than millimeter waves can be employed as the modulated signals.

Moreover, in the embodiments, the case is described in which the present technology is applied to (a communication system including) electronic devices that conform to the USB specifications. However, the present technology can be applied to electronic devices and the like that employ a system that detects a communication partner (connects to a communication partner) using a detected mechanism included in the communication partner, such as electronic devices including PCI Express as an interface, in addition to electronic devices that conform to USB devices.

Furthermore, in the communication system of FIG. 3, the communication unit 53 is configured to be included in the millimeter-wave connector 52. However, the communication unit 53 can be included at any position in the millimeter-wave cable 50 on the condition that a waveguide that transfers a modulated signal is formed in between with the communication unit 63. The communication unit 63 can also be included at any position in the millimeter-wave cable 60 other than the millimeter-wave connector 62 on the condition that a waveguide is formed in between with the communication unit 53.

Here, in the description, a system indicates a collection of a plurality of components (apparatuses, modules (parts), and the like), whether all the components are in the same housing or not. Therefore, a plurality of apparatuses that are housed in separate housings and are connected via a network, and one apparatus including one housing that houses a plurality of modules are both systems.

Moreover, the effects described in the description are merely exemplifications, and are not limited. There may be other effects.

Incidentally, the present technology can be configured as follows:

(1)

A communication apparatus including:

a detected mechanism corresponding to a mechanism included in a second electronic device that receives a baseband signal outputted by a first electronic device, the detected mechanism being configured to, upon the first electronic device and the second electronic device being connected, be detected by the first electronic device, and be connected to the first electronic device;

a connection unit configured to, upon a connection of the first and second electronic devices being detected, connect the detected mechanism to the first electronic device; and

a millimeter-wave generation unit configured to generate a signal in a millimeter wave band obtained by converting frequency from the baseband signal outputted by the first electronic device to a signal in a higher frequency band than the baseband signal,

in which upon the connection unit being connected and the baseband signal being inputted, the millimeter-wave generation unit generates the signal in the millimeter wave band.

(2)

The communication apparatus according to the (1), further including a signal detection unit configured to detect the baseband signal, in which upon the signal detection unit detecting the baseband signal, the millimeter-wave generation unit generates the signal in the millimeter wave band.

(3)

The communication apparatus according to the (2), in which upon the signal detection unit detecting the baseband signal, and a signal indicating a state where the connection of the first and second electronic devices is detected being supplied, the millimeter-wave generation unit generates the signal in the millimeter wave band.

(4)

The communication apparatus according to any of the (1) to (3), in which the detected mechanism, the connection unit, and the millimeter-wave generation unit are included in one integrated circuit (IC).

(5)

The communication apparatus according to any of the (1) to (4), in which the detected mechanism includes common-mode impedance.

(6)

A communication method of a communication apparatus having a detected mechanism corresponding to a mechanism included in a second electronic device that receives a baseband signal outputted by a first electronic device, the detected mechanism being configured to, upon the first electronic device and the second electronic device being connected, be detected by the first electronic device, and be connected to the first electronic device, the communication method including:

upon a connection of the first and second electronic devices being detected, connecting the detected mechanism to the first electronic device; and

generating a signal in a millimeter wave band obtained by converting frequency from the baseband signal outputted by the first electronic device to a signal in a higher frequency band than the baseband signal,

in which upon the detected mechanism being connected to the first electronic device and the baseband signal being inputted, the signal in the millimeter wave band is generated.

### REFERENCE SIGNS LIST

10 USB host
11 USB connector
20 USB device
21 USB connector
22 Detected mechanism
30 USB cable
31, 32 USB connector
50 Millimeter-wave cable
51 USB connector
52 Millimeter-wave connector
53 Communication unit
54 Detected mechanism
60 Millimeter-wave cable
61 USB connector
62 Millimeter-wave connector
63 Communication unit
71 Transmitting unit
72 Receiving unit
81 Transmitting unit
82 Receiving unit
101 Connection detection unit
121 IC
151, 152 Capacitor
153 Buffer
154 Amplifier
155 Signal detection unit
171 Mixer
172 Oscillator
173 Amplifier
201 Amplifier
202 Mixer
203 Amplifier
204, 205 Capacitor
310 USB host
311 USB interface
312 Millimeter-wave connector
313 Communication unit
320 USB device
321 USB interface
322 Millimeter-wave connector
323 Millimeter-wave connector
330 Millimeter-wave capable electrical cable
331, 332 Millimeter-wave connector
333, 334 Communication unit
350 Millimeter-wave transfer-purpose cable
351, 352 Millimeter-wave connector

1. A communication apparatus comprising:
a detected mechanism corresponding to a mechanism included in a second electronic device that receives a baseband signal outputted by a first electronic device, the detected mechanism being configured to, upon the first electronic device and the second electronic device being connected, be detected by the first electronic device, and be connected to the first electronic device;
a connection unit configured to, upon a connection of the first and second electronic devices being detected, connect the detected mechanism to the first electronic device; and
a millimeter-wave generation unit configured to generate a signal in a millimeter wave band obtained by converting frequency from the baseband signal outputted by the first electronic device to a signal in a higher frequency band than the baseband signal,
wherein upon the connection unit being connected and the baseband signal being inputted, the millimeter-wave generation unit generates the signal in the millimeter wave band.

2. The communication apparatus according to claim 1, further comprising a signal detection unit configured to detect the baseband signal, wherein upon the signal detection unit detecting the baseband signal, the millimeter-wave generation unit generates the signal in the millimeter wave band.

3. The communication apparatus according to claim 2, wherein upon the signal detection unit detecting the baseband signal, and a signal indicating a state where the connection of the first and second electronic devices is detected being supplied, the millimeter-wave generation unit generates the signal in the millimeter wave band.

4. The communication apparatus according to claim 1, wherein the detected mechanism, the connection unit, and the millimeter-wave generation unit are included in one integrated circuit (IC).

5. The communication apparatus according to claim 1, wherein the detected mechanism includes common-mode impedance.

6. A communication method of a communication apparatus including a detected mechanism corresponding to a mechanism included in a second electronic device that receives a baseband signal outputted by a first electronic device, the detected mechanism being configured to, upon the first electronic device and the second electronic device being connected, be detected by the first electronic device, and be connected to the first electronic device, the communication method comprising:
upon a connection of the first and second electronic devices being detected, connecting the detected mechanism to the first electronic device; and
generating a signal in a millimeter wave band obtained by converting frequency from the baseband signal outputted by the first electronic device to a signal in a higher frequency band than the baseband signal,
wherein upon the detected mechanism being connected to the first electronic device and the baseband signal being inputted, the signal in the millimeter wave band is generated.
